(19) United States
(12) Patent Application Publication
(10) Pub. No.: US 2017/0070387 A1
(43) Pub. Date: Mar. 9, 2017

(54) METHOD FOR PRO-ACTIVE TRAFFIC REDIRECTION IN MULTI-HOP WIRELESS NETWORKS USING SOFTWARE DEFINED NETWORKING

(71) Applicant: Telefonaktiebolaget L M Ericsson (publ), Stockholm (SE)

(72) Inventors: Kishan RAO, Bangalore (IN); Vinayak JOSHI, Bangalore (IN)

(21) Appl. No.: 14/849,381

(22) Filed: Sep. 9, 2015

(51) Int. Cl. H04L 12/24; H04L 12/26; H04L 12/751; H04L 12/707

(52) U.S. Cl. CPC H04L 41/0816; H04L 45/22; H04L 43/10; H04L 45/02

(57) ABSTRACT

A method and system are implemented by a controller in a software defined networking (SDN) network. The SDN network includes a set of nodes. The controller is in communication with a server providing information about environmental events affecting the SDN network. The method includes receiving information about an environmental event affecting the SDN network, identifying a subset of the nodes in the SDN network affected by the environmental event based on location information for the subset of nodes, determining a degree of impact caused by the environmental event for each node in the subset of nodes, and configuring the SDN network to diminish an impact of the environmental event on the SDN network performance.

### FIELD

Embodiments of the invention relate to the field of location aware routing and more specifically, to a process and system for managing traffic by anticipating changes in the network topology and availability, enhancing the detection of changes in operating throughput and availability, and/or preparing alternative configurations of the network routing.

### BACKGROUND

Multi-hop wireless network technologies involve network topologies where packets traverse a topology that includes multiple consecutive wireless links in order to reach their destinations, possibly spanning across an immensely vast area of communication. Multi-hop wireless network technologies can include packet radio networks, ad hoc networks, mobile networks and similar computer networks. Multi-hop wireless networks that have topologies with radio hops amongst the wireless hops can include microwave backhaul networks. Such networks are commonly deployed in a ring topology, although a mesh topology is also possible. Multi-hop wireless networks can also include public access mesh networks and sensor networks.

Thus, multi-hop wireless networks are affected by conditions that are not typically a significant factor in many other types of networks. Wireless networks communicating over different geological terrain and in differing weather conditions are susceptible to external events and conditions that can cause radio interference or affect the availability of some of the nodes in the network. Where a mobile node moves through a tunnel or where weather disrupts radio communications, the multi-hop wireless network is adversely affected. Traditional metrics in networks have limited ability to account for these conditions. Traditional metrics include monitoring link status and congestion levels in the network. In response to congestion or link failures, the network reconfigures to reroute data traffic around the failed links or nodes or to decrease the traffic on congested links or nodes.

These traditional metrics and the response to these metrics are reactive. That is, these metrics and the network configuration based on them can be used for corrective actions after a network link failure or disruption. This is a relatively slow process and such slow decision making can cause network disruptions. Additionally, due to the distributed nature of routing, the optimal usage of resources is not guaranteed.

### SUMMARY

In one embodiment, a method is implemented by a controller in a software defined networking (SDN) network. The SDN network includes a set of nodes. The controller is in communication with a server providing information about environmental events affecting the SDN network. The method includes receiving information about an environmental event affecting the SDN network, identifying a subset of the nodes in the SDN network affected by the environmental event based on location information for the subset of nodes, determining a degree of impact caused by the environmental event for each node in the subset of nodes, and configuring the SDN network to diminish an impact of the environmental event on the SDN network performance.

In another embodiment, a network device functions as a controller in an SDN network. The SDN network includes a set of nodes. The controller is in communication with a server providing information about environmental events affecting the SDN network. The network device includes a non-transitory machine readable storage device having stored therein a location impact analyzer and a path manager, and a processor coupled to the non-transitory machine readable storage device. The processor is configured to execute the location impact analyzer and the path manager. The location impact analyzer is configured to receive information about an environmental event affecting the SDN network, to identify a subset of the nodes in the SDN network affected by the environmental event based on location information for the subset of nodes, and to determine a degree of impact caused by the environmental event for each node in the subset of nodes, and the path manager is configured to configure the SDN network to diminish an impact of the environmental event on the SDN network performance.

### BRIEF DESCRIPTION OF THE DRAWINGS

The invention may best be understood by referring to the following description and accompanying drawings that are used to illustrate embodiments of the invention. In the drawings:

FIG. 1 is a diagram of one embodiment of a network implementing the pro-active traffic redirection process and system.

FIG. 2 is a diagram of one embodiment of a process for pro-active traffic redirection.

FIG. 3 is a diagram of one embodiment of an example implementation of the pro-active traffic redirection path manager process.

FIG. 4A is a diagram of one embodiment of an example application of the process to perform enhanced monitoring in a network topology.

FIG. 4B is a diagram of one embodiment of an example application of the process to perform traffic re-routing in a network topology.

FIG. 5A illustrates connectivity between network devices (NDs) within an exemplary network, as well as three exemplary implementations of the NDs, according to some embodiments of the invention.

FIG. 5B illustrates an exemplary way to implement a special-purpose network device according to some embodiments of the invention.

FIG. 5C illustrates various exemplary ways in which virtual network elements (VNEs) may be coupled according to some embodiments of the invention.

FIG. 5D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 5E illustrates the simple case of where each of the NDs implements a single NE, but a centralized control plane has abstracted multiple of the NEs in different NDs into (to represent) a single NE in one of the virtual network(s), according to some embodiments of the invention.

FIG. 5F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 6 illustrates a general purpose control plane device with centralized control plane (CCP) software, according to some embodiments of the invention.

### DESCRIPTION OF EMBODIMENTS

The following description describes methods and apparatus for managing traffic in a multi-hop wireless network by anticipating changes in the network topology and availability, enhancing the detection of changes in operating throughput and availability, and/or preparing alternative configurations of the network routing. The embodiments include utilizing data received from outside of the multi-hop wireless network such as weather, power outage, and similar environmental conditions. This information is analyzed to identify an area affected and the area is correlated with nodes in the network to identify those nodes affected by the external event described in the received information. The degree to which each node is affected and the decision to generate alternate routes or to schedule heightened levels of monitoring is made to ameliorate the effect of the external events on the network.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

Overview

In addition to metrics used in regular routing protocols (e.g., link status and congestion), the routing protocols utilized in multi-hop wireless networks have to consider radio interference, impact of weather on radio link conditions and similar events. A centralized view and control of the complete network can help immensely in optimization and path redundancy of such networks.

In one embodiment, a software defined networking (SDN) controller can be configured to control networks and to participate in a pro-active traffic redirection process. For example, a Multi-Layer WAN Controller (MLWC) by Ericsson of Stockholm, Sweden can be configured to control the L0-L3 aspects of Mobile Back Haul (MBH) networks. In the current available version it controls Optical MBH networks. In other embodiments, a SDN controller can be utilized with Microwave based MBH networks or similar networks. The pro-active traffic redirection process and system can be utilized with any network topology and is particularly suited to be utilized in connection with networks such as multi-hop wireless networks and similar networks and technologies that can be affected by environmental conditions.

Optimization in this area is beneficial to improving network resource availability and the overall efficiency and throughput of such networks and technologies. The embodiments of the pro-active traffic redirection process and system provide a method for proactively using information about the impact of external conditions such as weather and power outages at nodes and links, e.g., radio node physical locations, for path optimization and redundancy. The embodiments of the pro-active traffic redirection process and system also exploit the advantages of the SDN concept. An SDN controller has a centralized view and control of the network (southbound of the controller). Unlike typical element management system/network management system (EMS/NMS) applications, SDN controllers are not closed in the sense that they provide open interfaces on the northbound side for external application integration. This makes implementing the pro-active traffic redirection process and system compatible with the standard use of an SDN controller. Alternatively, traditional methods are used for the same in the existing protocols/technologies such as modification of EMS/NMS systems.

Typically radio link quality/status change is fed into the routing protocols/algorithms which use them as metrics for routing decisions. Upper layer protocols such as virtual router redundancy protocol (VRRP), link aggregation control protocol (LACP) or the equivalents are used for redundancy of network elements and paths. Thus, in the alternative embodiments, the pro-active traffic redirection process and system can also be compatible with these technologies.

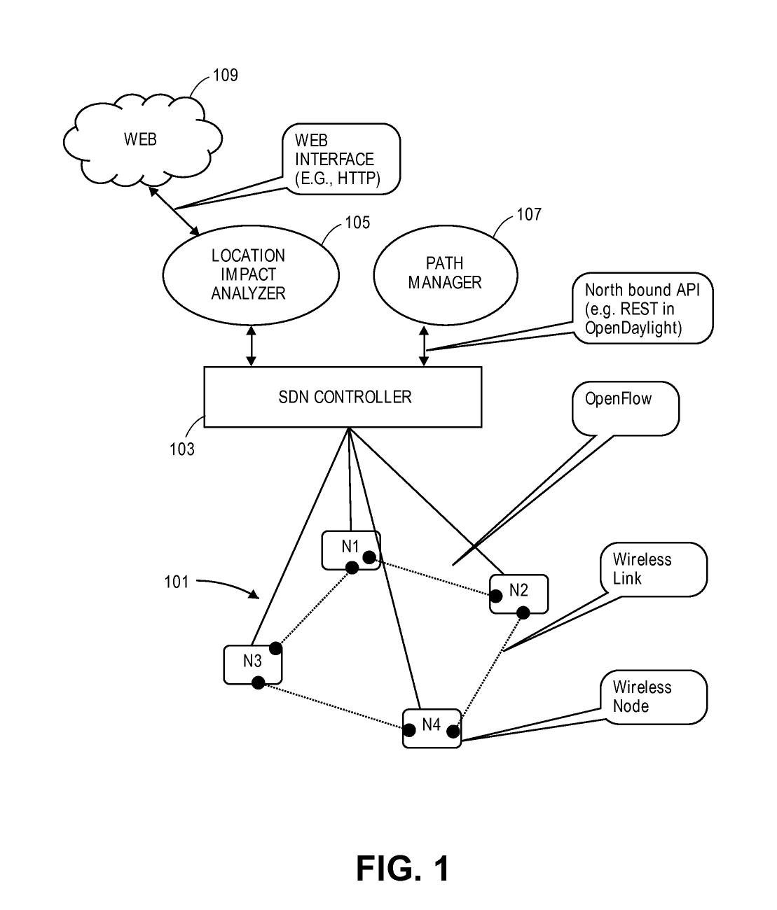

FIG. 1 is a diagram of one embodiment of an example network implementing pro-active traffic redirection. In the example illustrated network, the network 101 can be a radio network that includes four radio nodes N1 . . . N4, controlled by one SDN controller 103. In this example, the pro-active traffic redirection process is implemented via two applications, a location impact analyzer 105 and a path manager 107, illustrated as being outside the SDN controller 103. The location impact analyzer 105 and the path manager 107 can be implemented as separate applications or as a single integrated application. The location impact analyzer 105 and the path manager 107 can be implemented within the SDN controller 103 or can be implemented in separate devices.

The SDN controller 103 can utilize a protocol such as OpenFlow or similar flow control to communicate with the underlying network 101. The OpenFlow protocol can be utilized with some extensions, or the flow control protocol that is utilized can be selected as the control protocol considering its capabilities as described further herein below. The embodiments do not preclude other flow control or control protocols that provide similar capabilities.

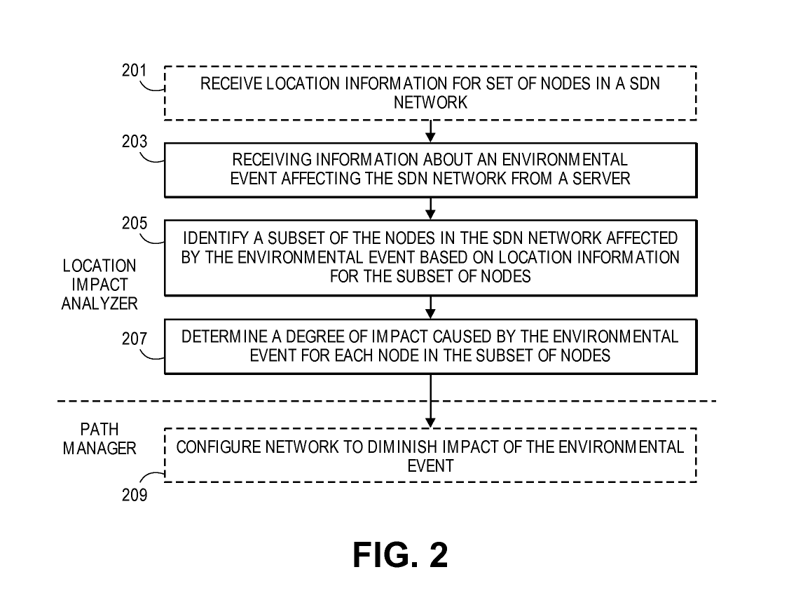

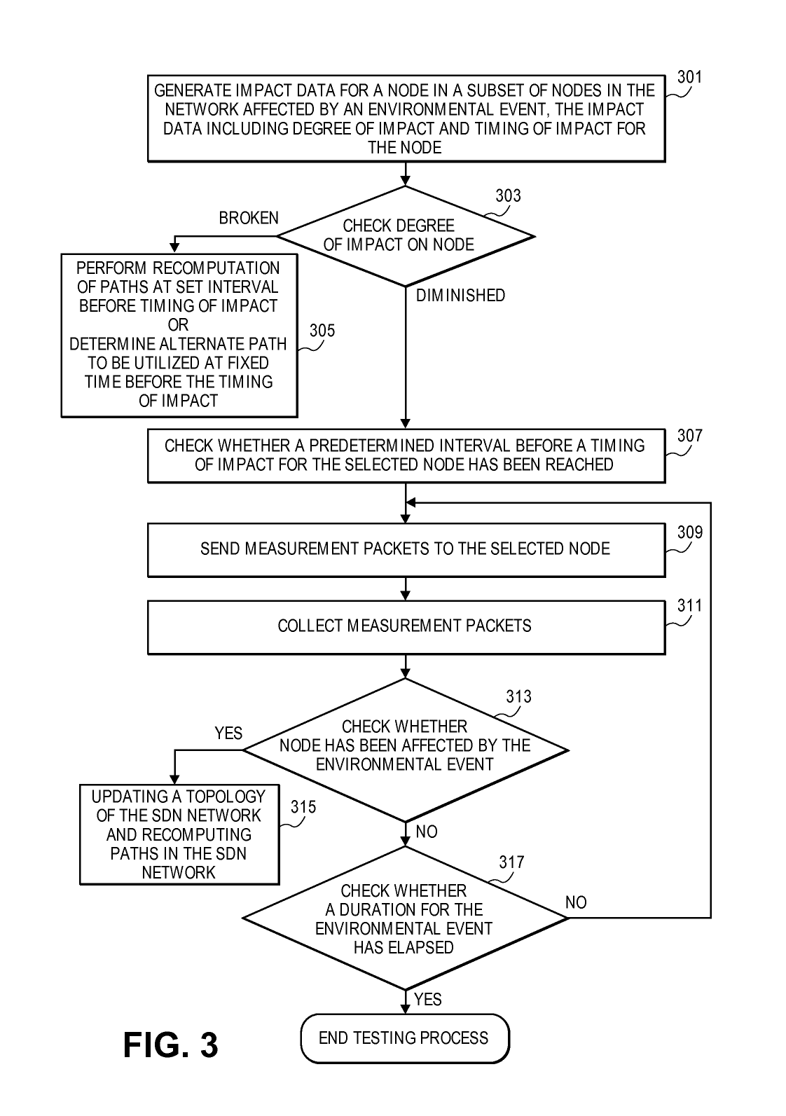

FIG. 2 is a diagram of one embodiment of the pro-active traffic redirection process. An implementation of the related path manager process is described herein below with regard to FIG. 3. In this basic embodiment, the process optionally receives location information for a set of nodes in an SDN network (Block 201). In one embodiment, the SDN controller obtains the physical co-ordinates of the nodes (e.g., radio nodes in FIG. 1) and provides them to the location impact analyzer. Obtaining physical co-ordinates of radio nodes can be accomplished using any of a number of methods. For static (i.e., fixed location) radio nodes, manual input at network installation can provide the global positioning service (GPS) co-ordinates of the nodes. In other embodiments, the fixed location radio nodes may include GPS devices or may use other sensors to determine and report their location. For mobile nodes, any of the following methods can be used. The mobile nodes may report to the controller using triangulation methods (e.g., wireless signal triangulation) or the mobile nodes can be fitted with location sensors. In one example embodiment, mobile nodes can be fitted with a GPS device and the GPS co-ordinates can be reported to the SDN controller using OpenFlow or similar flow control messages. An extension using the OFPMP EXPERIMENTER message type of OpenFlow protocol can be utilized so that the node provides GPS co-ordinates to the controller at node boot-up and restart as well as whenever the location of the node changes beyond a threshold distance that is significant enough for the GPS co-ordinates to be reported to the SDN controller. The threshold distance can be configurable by the SDN controller using OpenFlow or a similar flow control protocol. This extension is along the lines of the standard Switch Capabilities OpenFlow message.

In some embodiments, the location impact analyzer obtains environmental event information such as weather predictions, information about planned electrical outages with respect to the co-ordinates over the web, or similar environmental event information (Block 203). As used herein, “environmental event” is used to refer to any man-made or naturally occurring event that may affect the operation of nodes and/or links in a network. This environmental event can be, for example, a planned power outage, weather affecting transmissions, solar flares affecting satellites, planned network maintenance or similar events that affect node and/or link availability in a network and are distinct from internal network traffic congestion, routing and path finding issues. The environmental event information can be obtained from public servers or specialized services. There are many websites that provide the weather prediction based on GPS co-ordinates (e.g., www.weather.gov). The embodiments benefit from environmental event information that has a higher level of granularity and accuracy. The location impact analyzer can use the hypertext transfer protocol (HTTP) to obtain this information (e.g., by querying weather tickers). Electrical supply companies also provide warnings about planned outages through SMS and e-mails. This information can also be monitored and provided as input to the SDN controller. Any similar environmental event information can similarly be monitored, subscribed to or processed as input for the location impact analyzer.

The location impact analyzer analyses the impact of the environmental event information, for example weather changes (i.e., snow with its water content can impact unlicensed bands), to identify the subset of nodes in the SDN network that are affected (Block 205). For static wireless nodes, this is a basic comparison of derived affected geographical location information with the location information of the nodes in the network. For mobile nodes, additional calculations are made to determine their expected location at the time of impact of the environmental event. In many cases, the future location of the mobile nodes also can be predicted (e.g., trains carrying IEEE 802.11 based mesh nodes). The output of this analysis can be, for example, a list of impacted nodes, which is a subset of the total set of nodes in the SDN network. In some embodiments, additional computation is made to identify affected nodes in the network managed by an SDN controller. The location impact analyzer can perform a computation to determine the degree of impact (Block 207). The degree of impact can be determined based on the proximity of the node's location to the environmental event. For example, nodes closest to the center of the environmental event may be more significantly affected than those at a periphery of the environmental event. The method of calculation can vary depending on the type of the environmental event. Weather conditions for example can have expected patterns of effect and duration using a model for snow or rain, whereas power outages have a specific area of effect and duration. The impact can also be determined with a confidence level that indicates a percentage of probability that the environmental event will occur. The output of the location impact analyzer can pass to the SDN controller or directly to a path manager.

The path manager processes the impact information output by the location impact analyzer either directly or indirectly. The path manager application uses this feedback to configure the network to diminish the impact of the environmental event by redirecting the network traffic pro-actively (Block 209). In one example, the impact of weather on radio hops may not be very accurate both in terms of time prediction and severity. Hence the SDN controller via the path manager can schedule network measurement (e.g., delay, jitter and packet drop) activity a defined period before the links are predicted to be affected. This is implemented by sending/receiving network measurement packets to/from the nodes affected, or to/from the nodes adjacent to each link that is anticipated to be affected. This is more efficient than measuring all paths in the network all the time since only a subset of the paths is measured and only for a short duration. Measuring all paths all the time does not scale, and measuring or monitoring links and nodes on a regular basis consumes a significant amount of network and node resources. This selective enhanced monitoring and measurement minimizes network wide monitoring and measuring activities and the use of node and network resources. The communications related to monitoring and measurement themselves can cause significant network load. The information thus obtained is used to update network topology information and for path computations. This pro-active monitoring and measurement reduces network disruptions compared to reactive corrections which get performed by traditional routing.

In one embodiment, if a node outage is imminent (e.g., due to an electrical outage) the path manager can schedule fast re-route of traffic such that affected paths are avoided. In some areas, electrical outages may seldom occur (considering battery back-ups are available in many cases); however when they do occur, it can be catastrophic. The pro-active traffic redirection can be performed more efficiently and accurately in networks where there is an SDN controller, because the SDN controller has the complete picture of the network topology and control of the configuration of the network. The physical locations of mobile nodes are updated, and this information is provided to the SDN controller when the locations change. The location impact analyzer and path manager can be executed by, or in communication with, the SDN controller such that it can constantly monitor the external impact and the cycle of external events and traffic redirection in an ongoing process that is repeated whenever necessary.

The embodiments provide advantages and overcome the defects of the prior art. The pro-active traffic redirection process bridges the application space and the networking space through the SDN controller. The environmental events influencing routing are directly inducted into routing which might otherwise require manual intervention. Instead of using the traditional routing updates, which are re-active in nature, proactive route computation allows more efficient and reliable routing. Since the SDN controller has the complete view of the network topology and configuration and control of the network, it can achieve very efficient network measurement and routing. In turn, the location impact analyzer and the path manager can utilize this information for a better quality of service even in emergency situations.

FIG. 3 is a flowchart of one embodiment of an example implementation of the pro-active traffic redirection path manager process. This process is initiated in response to receiving impact data for a node in a subset of nodes in the network affected by an environmental event (Block 301), where the location impact analyzer has output information about a subset of nodes (e.g., by any type of node address or identifier) along with a degree of impact (e.g., offline, percentage of throughput decrease or similar assessment). The information from the location impact analyzer can also identify a time or time range during which the environmental event will disrupt the network. The path manager may obtain the information about the subset of impacted nodes at time T1 and the impact may be predicted to occur at time T2. The path manager determines how to handle two scenarios including one with less than 100% confidence and another with 100% confidence level.

A check may be made whether the provided degree of impact or confidence level indicates that the affected node or link will be broken (e.g., a 100% confidence level of failure such as a planned power outage) or whether the affected node or link will have a diminished capacity (e.g., less than 100% confidence level of failure or a known event having only an effect on bandwidth such as weather interference) (Block 303). In many cases the predictions cannot be accurate in terms of degree of impact and time of impact. In such cases the controller proactively measures network delay, jitter and/or loss so that these parameters can be used in path computation. The measurement activity is confined to a partial segment of the network. Hence, the controller can be rigorous in measuring that segment to hasten detection of deterioration of links.

The enhanced monitoring can be implemented by checking whether a predetermined interval before a timing of impact for the selected node has been reached (Block 307). The process then sends measurement packets to the selected node that is the node for which enhanced monitoring is needed or, in the alternative, over links that need the enhanced monitoring (Block 309). The measurement packets, or responses to the measurement packets, are then received back (Block 311). The received measurement packets can then be examined to check whether the node or link being monitored has been affected by the environmental event (Block 313). If the latency, packet loss or similar measurements indicate that the node or link have been affected by the environmental event, then the network topology may be updated to reflect the change in the characteristics of the link or node, for example, indicating lower bandwidth or processing capabilities or that congestion is occurring at the node or link (Block 315). This can lead to a recomputation of the paths and traffic routing in the network. However, if the measurement packets do not indicate an effect of the environmental event on the monitored node or link, then a check may be made whether a duration of the environmental event has lapsed (Block 317). If the event is ongoing, then the monitoring process can continue (Block 309). However, if the duration of the environmental event has lapsed then the monitoring can be terminated or completed.

In a situation where the confidence level indicates that the node or link will fail, then the process can perform a recomputation of paths at a set interval before the timing of the impact of the environmental event, or an alternate path to be utilized at a fixed time before the timing of the impact of the environmental event can be determined (Block 305). These and similar options can be utilized and configured for utilization to avoid interruption of service by performing a transition to the alternate path that has been computed.

The operations in this and other flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

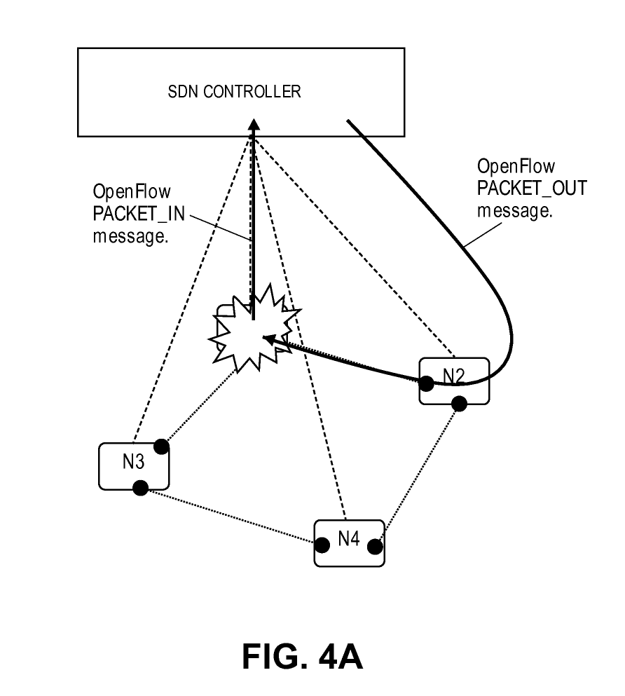

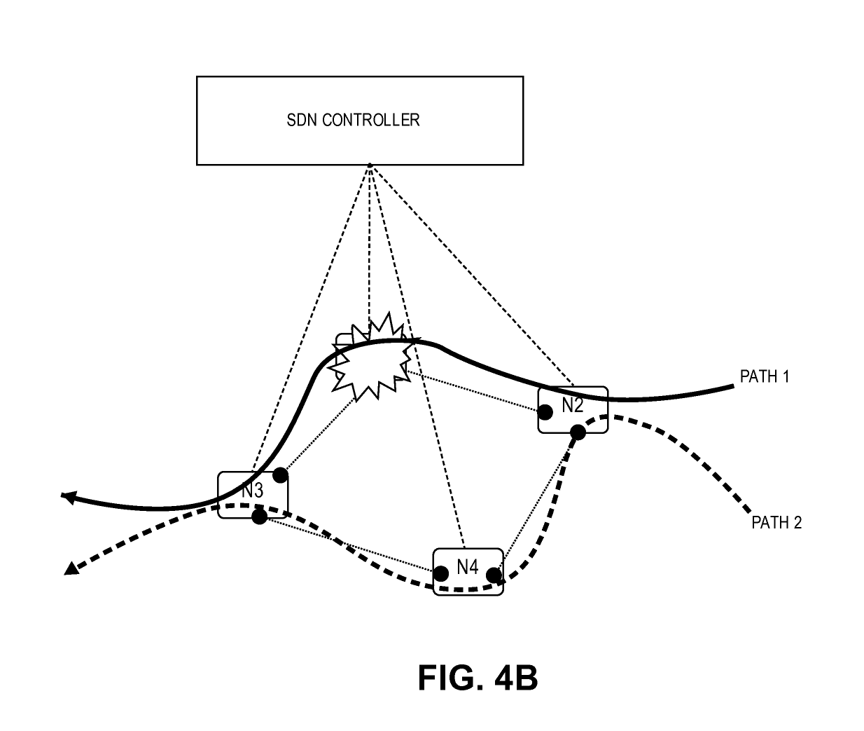

FIG. 4A is a diagram of one embodiment of the enhanced monitoring. Enhanced monitoring is explained with reference to the example shown in the FIG. 4A. In this example at time T1, the location impact analyzer conveys the prediction to the SDN controller and the path manager that node N1 may be impacted due to weather change (e.g., snowfall) at time T2. The degree of impact and time of impact are approximate. Hence, the controller initiates the enhanced monitoring and measurement cycle at time (T1+t′) where (T1+t′)<<T2.

For link quality measurements, for example for link N2 [symbol] N1, the path manager performs the following steps (e.g., it may be based on time stamping based measurements described in the Two-Way Active Measurement Protocol (TWAMP) (RFC 5357) and the One-Way Active Measurement Protocol (OWAMP) (RFC 4656).

A series of measurement packets are sent from the SDN controller in the form of OpenFlow PACKET_OUT to node N2.

N2 forwards these measurement packets towards N1. This can be programmed by the SDN controller using standard OpenFlow.

N1 forwards the measurement packets towards the SDN controller using the PACKET_IN messages. This, too, can be programmed by the SDN controller using standard OpenFlow.

N1 and N2 also record the measurement packet arrival time stamps before forwarding the measurement packets, where the time stamps at nodes N2 and N1 are N^{T}₂ and N^{T}₁, respectively. This can be implemented with an extension to the OpenFlow protocol (any revision).

Matching the egress/ingress measurement packet counts, the SDN controller can measure the packet loss metric of the link.

If N1 and N2 are synced in time outside OpenFlow (e.g., using Precision Time Protocol (PTP)), then N^{T}₁−N^{T}2 provides the latency of the link.

Even if N1 and N2 are time synced, the difference (N^{T}₁−N^{T}₂) increases as link quality deteriorates.

The jitter of the link can be determined using the latency. These link metrics can be used in path computation. The path recomputation algorithm can then be executed with updated topology information to reroute the traffic. The path computation can offload traffic much before time T2 thus avoiding service loss. Reliability and load balancing factors are considered for such traffic redirections.

FIG. 4B is a diagram of an example of traffic re-routing where a broken path or node failure is expected. In some cases (e.g., power outage), the degree of impact as determined by the location impact analyzer can be such that some nodes, links (e.g., radio links) can fail or be broken completely at time T2, where the location impact analyzer conveys this information to the SDN controller at an earlier time T1. In such cases, the path manager performs any of the following: Option1: Schedule a new path computation to occur at time (T1+t) where (T1+t)<T2. The new path computation that excludes the affected links and the paths thus computed are programed into the nodes before the affected links are broken at time T2. Option 2: At time T1, a new path computation is performed and the OpenFlow hard time-out mechanism is used to re-route the traffic before the affected links are broken at time T2.

In reference to FIG. 4B, the node N1 is predicted to go down at time T2 and other nodes are predicted to stay on. Hence, the path manager determines that Path1 (i.e., N2 [symbol] N1 [symbol] N3) is going to be impacted. However, shifting all traffic on Path1 to the alternate Path 2 (i.e., N2 [symbol] N4 [symbol] N3) immediately at time T1 is inefficient. Hence, the path manager can use the OpenFlow hard time-out mechanism to achieve the same as mentioned in Option 2 above.

In one example, a flow F1 exists on node N2 that carries all or part of the traffic to node N3 via node N1 (i.e., Path1).

Flow F2, which has the same match conditions as F1, is added in N2. The priority of F2 should be less than that of F1. This is for carrying traffic on Path 2.

A Flow Mod message is used for setting a hard time out of time t, where (T1+t)<T2.

F1ows corresponding to flow F2 are added in N4 and N3 also to set up the complete Path2.

Up to time T1+t, traffic is still carried on Path 1 due to the higher priority of F1, relative to the priority of F2.

At time T1+t, i.e., before T2, node N2 would remove F1 due to the hard time out, and traffic begins to traverse using F2 on Path 2. This provides a “make-before-break” mechanism.

Architecture

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

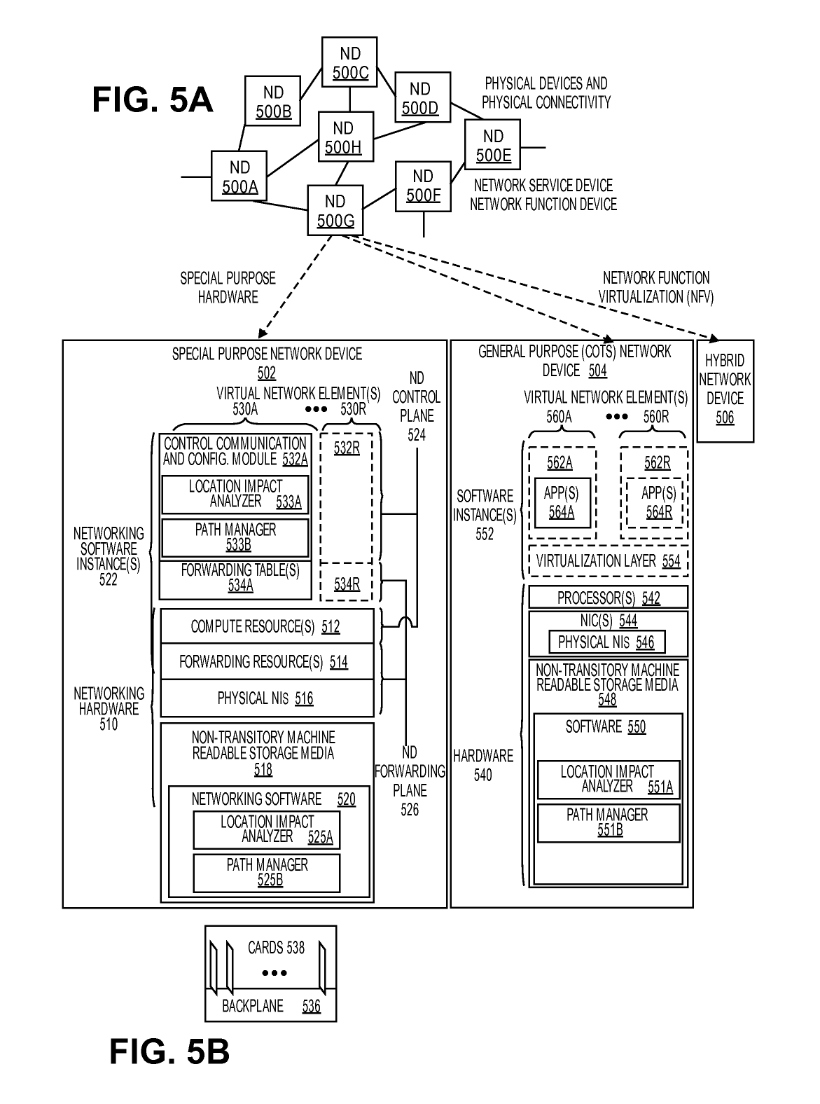

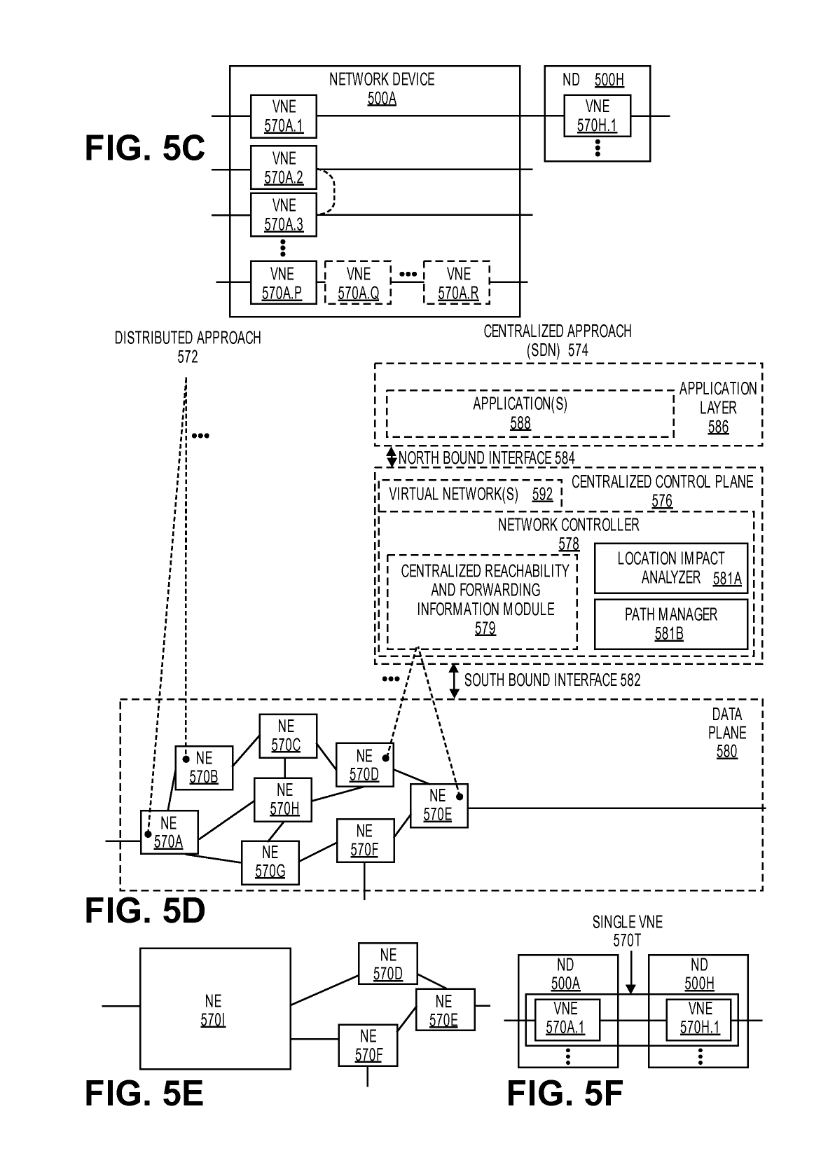

FIG. 5A illustrates connectivity between network devices (NDs) within an exemplary network, as well as three exemplary implementations of the NDs, according to some embodiments of the invention. FIG. 5A shows NDs 500A-H, and their connectivity by way of lines between A-B, B-C, C-D, D-E, E-F, F-G, and A-G, as well as between H and each of A, C, D, and G. These NDs are physical devices, and the connectivity between these NDs can be wireless or wired (often referred to as a link) An additional line extending from NDs 500A, E, and F illustrates that these NDs act as ingress and egress points for the network (and thus, these NDs are sometimes referred to as edge NDs; while the other NDs may be called core NDs).

Two of the exemplary ND implementations in FIG. 5A are: 1) a special-purpose network device 502 that uses custom application-specific integrated-circuits (ASICs) and a proprietary operating system (OS); and 2) a general purpose network device 504 that uses common off-the-shelf (COTS) processors and a standard OS.

The special-purpose network device 502 includes networking hardware 510 comprising compute resource(s) 512 (which typically include a set of one or more processors), forwarding resource(s) 514 (which typically include one or more ASICs and/or network processors), and physical network interfaces (NIs) 516 (sometimes called physical ports), as well as non-transitory machine readable storage media 518 having stored therein networking software 520. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 500A-H. During operation, the networking software 520 may be executed by the networking hardware 510 to instantiate a set of one or more networking software instance(s) 522. Each of the networking software instance(s) 522, and that part of the networking hardware 510 that executes that network software instance (be it hardware dedicated to that networking software instance and/or time slices of hardware temporally shared by that networking software instance with others of the networking software instance(s) 522), form a separate virtual network element 530A-R. Each of the virtual network element(s) (VNEs) 530A-R includes a control communication and configuration module 532A-R (sometimes referred to as a local control module or control communication module) and forwarding table(s) 534A-R, such that a given virtual network element (e.g., 530A) includes the control communication and configuration module (e.g., 532A), a set of one or more forwarding table(s) (e.g., 534A), and that portion of the networking hardware 510 that executes the virtual network element (e.g., 530A).

Software 520 can include code which when executed by networking hardware 510, causes networking hardware 510 to perform operations of one or more embodiments of the present invention as part networking software instances 522. That is the networking software 520 can include the location impact analyzer 525A and path manager 525B that implement the functions described herein above. This network software 520 is executed as part of the networking software instances 522 as the location impact analyzer 533A and path manager 533B.

The special-purpose network device 502 is often physically and/or logically considered to include: 1) a ND control plane 524 (sometimes referred to as a control plane) comprising the compute resource(s) 512 that execute the control communication and configuration module(s) 532A-R; and 2) a ND forwarding plane 526 (sometimes referred to as a forwarding plane, a data plane, or a media plane) comprising the forwarding resource(s) 514 that utilize the forwarding table(s) 534A-R and the physical NIs 516. By way of example, where the ND is a router (or is implementing routing functionality), the ND control plane 524 (the compute resource(s) 512 executing the control communication and configuration module(s) 532A-R) is typically responsible for participating in controlling how data (e.g., packets) is to be routed (e.g., the next hop for the data and the outgoing physical NI for that data) and storing that routing information in the forwarding table(s) 534A-R, and the ND forwarding plane 526 is responsible for receiving that data on the physical NIs 516 and forwarding that data out the appropriate ones of the physical NIs 516 based on the forwarding table(s) 534A-R.

FIG. 5B illustrates an exemplary way to implement the special-purpose network device 502 according to some embodiments of the invention. FIG. 5B shows a special-purpose network device including cards 538 (typically hot pluggable). While in some embodiments the cards 538 are of two types (one or more that operate as the ND forwarding plane 526 (sometimes called line cards), and one or more that operate to implement the ND control plane 524 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 536 (e.g., a first full mesh coupling the line cards and a second full mesh coupling all of the cards).

Returning to FIG. 5A, the general purpose network device 504 includes hardware 540 comprising a set of one or more processor(s) 542 (which are often COTS processors) and network interface controller(s) 544 (NICs; also known as network interface cards) (which include physical NIs 546), as well as non-transitory machine readable storage media 548 having stored therein software 550. During operation, the processor(s) 542 execute the software 550 to instantiate one or more sets of one or more applications 564A-R. While one embodiment does not implement virtualization, alternative embodiments may use different forms of virtualization—represented by a virtualization layer 554 and software containers 562A-R. For example, one such alternative embodiment implements operating system-level virtualization, in which case the virtualization layer 554 represents the kernel of an operating system (or a shim executing on a base operating system) that allows for the creation of multiple software containers 562A-R that may each be used to execute one of the sets of applications 564A-R. In this embodiment, the multiple software containers 562A-R (also called virtualization engines, virtual private servers, or jails) are each a user space instance (typically a virtual memory space), these user space instances are separate from each other and separate from the kernel space in which the operating system is run; the set of applications running in a given user space, unless explicitly allowed, cannot access the memory of the other processes. Another such alternative embodiment implements full virtualization, in which case: 1) the virtualization layer 554 represents a hypervisor (sometimes referred to as a virtual machine monitor (VMM)) or a hypervisor executing on top of a host operating system; and 2) the software containers 562A-R each represent a tightly isolated form of software container called a virtual machine that is run by the hypervisor and may include a guest operating system. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes.

The instantiation of the one or more sets of one or more applications 564A-R, as well as the virtualization layer 554 and software containers 562A-R if implemented, are collectively referred to as software instance(s) 552. Each set of applications 564A-R, corresponding software container 562A-R if implemented, and that part of the hardware 540 that executes them (be it hardware dedicated to that execution and/or time slices of hardware temporally shared by software containers 562A-R), forms a separate virtual network element(s) 560A-R.

The virtual network element(s) 560A-R perform similar functionality to the virtual network element(s) 530A-R—e.g., similar to the control communication and configuration module(s) 532A and forwarding table(s) 534A (this virtualization of the hardware 540 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). However, different embodiments of the invention may implement one or more of the software container(s) 562A-R differently. For example, while embodiments of the invention are illustrated with each software container 562A-R corresponding to one VNE 560A-R, alternative embodiments may implement this correspondence at a finer level granularity (e.g., line card virtual machines virtualize line cards, control card virtual machine virtualize control cards, etc.); it should be understood that the techniques described herein with reference to a correspondence of software containers 562A-R to VNEs also apply to embodiments where such a finer level of granularity is used.

In certain embodiments, the virtualization layer 554 includes a virtual switch that provides similar forwarding services as a physical Ethernet switch. Specifically, this virtual switch forwards traffic between software containers 562A-R and the NIC(s) 544, as well as optionally between the software containers 562A-R; in addition, this virtual switch may enforce network isolation between the VNEs 560A-R that by policy are not permitted to communicate with each other (e.g., by honoring virtual local area networks (VLANs)).

Software 550 can include code which when executed by processor(s) 542, cause processor(s) 542 to perform operations of one or more embodiments of the present invention as part software containers 562A-R. That is the software 550 can include the location impact analyzer 551A and path manager 551 B that implement the functions described herein above. This software 550 is executed as part of the software instances 552 as the location impact applications 564A-R.

The third exemplary ND implementation in FIG. 5A is a hybrid network device 506, which includes both custom ASICs/proprietary OS and COTS processors/standard OS in a single ND or a single card within an ND. In certain embodiments of such a hybrid network device, a platform VM (i.e., a VM that that implements the functionality of the special-purpose network device 502) could provide for para-virtualization to the networking hardware present in the hybrid network device 506.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 530A-R, VNEs 560A-R, and those in the hybrid network device 506) receives data on the physical NIs (e.g., 516, 546) and forwards that data out the appropriate ones of the physical NIs (e.g., 516, 546). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services (DSCP) values.

FIG. 5C illustrates various exemplary ways in which VNEs may be coupled according to some embodiments of the invention. FIG. 5C shows VNEs 570A.1-570A.P (and optionally VNEs 570A.Q-570A.R) implemented in ND 500A and VNE 570H.1 in ND 500H. In FIG. 5C, VNEs 570A.1-P are separate from each other in the sense that they can receive packets from outside ND 500A and forward packets outside of ND 500A; VNE 570A.1 is coupled with VNE 570H.1, and thus they communicate packets between their respective NDs; VNE 570A.2-570A.3 may optionally forward packets between themselves without forwarding them outside of the ND 500A; and VNE 570A.P may optionally be the first in a chain of VNEs that includes VNE 570A.Q followed by VNE 570A.R (this is sometimes referred to as dynamic service chaining, where each of the VNEs in the series of VNEs provides a different service—e.g., one or more layer 4-7 network services). While FIG. 5C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 5A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 5A may also host one or more such servers (e.g., in the case of the general purpose network device 504, one or more of the software containers 562A-R may operate as servers; the same would be true for the hybrid network device 506; in the case of the special-purpose network device 502, one or more such servers could also be run on a virtualization layer executed by the compute resource(s) 512); in which case the servers are said to be co-located with the VNEs of that ND.

A virtual network is a logical abstraction of a physical network (such as that in FIG. 5A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2 TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

FIG. 5D illustrates a network with a single network element on each of the NDs of FIG. 5A, and within this straight forward approach contrasts a traditional distributed approach (commonly used by traditional routers) with a centralized approach for maintaining reachability and forwarding information (also called network control), according to some embodiments of the invention. Specifically, FIG. 5D illustrates network elements (NEs) 570A-H with the same connectivity as the NDs 500A-H of FIG. 5A.

FIG. 5D illustrates that the distributed approach 572 distributes responsibility for generating the reachability and forwarding information across the NEs 570A-H; in other words, the process of neighbor discovery and topology discovery is distributed.

For example, where the special-purpose network device 502 is used, the control communication and configuration module(s) 532A-R of the ND control plane 524 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP)), Label Distribution Protocol (LDP), Resource Reservation Protocol (RSVP), as well as RSVP-Traffic Engineering (TE): Extensions to RSVP for LSP Tunnels, Generalized Multi-Protocol Label Switching (GMPLS) Signaling RSVP-TE that communicate with other NEs to exchange routes, and then selects those routes based on one or more routing metrics. Thus, the NEs 570A-H (e.g., the compute resource(s) 512 executing the control communication and configuration module(s) 532A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 524. The ND control plane 524 programs the ND forwarding plane 526 with information (e.g., adjacency and route information) based on the routing structure(s). For example, the ND control plane 524 programs the adjacency and route information into one or more forwarding table(s) 534A-R (e.g., Forwarding Information Base (FIB), Label Forwarding Information Base (LFIB), and one or more adjacency structures) on the ND forwarding plane 526. For layer 2 forwarding, the ND can store one or more bridging tables that are used to forward data based on the layer 2 information in that data. While the above example uses the special-purpose network device 502, the same distributed approach 572 can be implemented on the general purpose network device 504 and the hybrid network device 506.

FIG. 5D illustrates that a centralized approach 574 (also known as software defined networking (SDN)) that decouples the system that makes decisions about where traffic is sent from the underlying systems that forwards traffic to the selected destination. The illustrated centralized approach 574 has the responsibility for the generation of reachability and forwarding information in a centralized control plane 576 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 576 has a south bound interface 582 with a data plane 580 (sometime referred to the infrastructure layer, network forwarding plane, or forwarding plane (which should not be confused with a ND forwarding plane)) that includes the NEs 570A-H (sometimes referred to as switches, forwarding elements, data plane elements, or nodes). The centralized control plane 576 includes a network controller 578, which includes a centralized reachability and forwarding information module 579 that determines the reachability within the network and distributes the forwarding information to the NEs 570A-H of the data plane 580 over the south bound interface 582 (which may use the OpenFlow protocol). Thus, the network intelligence is centralized in the centralized control plane 576 executing on electronic devices that are typically separate from the NDs.

For example, where the special-purpose network device 502 is used in the data plane 580, each of the control communication and configuration module(s) 532A-R of the ND control plane 524 typically include a control agent that provides the VNE side of the south bound interface 582. In this case, the ND control plane 524 (the compute resource(s) 512 executing the control communication and configuration module(s) 532A-R) performs its responsibility for participating in controlling how data (e.g., packets) is to be routed (e.g., the next hop for the data and the outgoing physical NI for that data) through the control agent communicating with the centralized control plane 576 to receive the forwarding information (and in some cases, the reachability information) from the centralized reachability and forwarding information module 579 (it should be understood that in some embodiments of the invention, the control communication and configuration module(s) 532A-R, in addition to communicating with the centralized control plane 576, may also play some role in determining reachability and/or calculating forwarding information—albeit less so than in the case of a distributed approach; such embodiments are generally considered to fall under the centralized approach 574, but may also be considered a hybrid approach).

While the above example uses the special-purpose network device 502, the same centralized approach 574 can be implemented with the general purpose network device 504 (e.g., each of the VNE 560A-R performs its responsibility for controlling how data (e.g., packets) is to be routed (e.g., the next hop for the data and the outgoing physical NI for that data) by communicating with the centralized control plane 576 to receive the forwarding information (and in some cases, the reachability information) from the centralized reachability and forwarding information module 579; it should be understood that in some embodiments of the invention, the VNEs 560A-R, in addition to communicating with the centralized control plane 576, may also play some role in determining reachability and/or calculating forwarding information—albeit less so than in the case of a distributed approach) and the hybrid network device 506. In fact, the use of SDN techniques can enhance the NFV techniques typically used in the general purpose network device 504 or hybrid network device 506 implementations as NFV is able to support SDN by providing an infrastructure upon which the SDN software can be run, and NFV and SDN both aim to make use of commodity server hardware and physical switches.

Location impact analyzer 581A and path manager 581B can be implemented as modules at the network controller 578 level. However, in other embodiments the location impact analyzer 581A and path manager 581B are implemented as Applications 588.

FIG. 5D also shows that the centralized control plane 576 has a north bound interface 584 to an application layer 586, in which resides application(s) 588. The centralized control plane 576 has the ability to form virtual networks 592 (sometimes referred to as a logical forwarding plane, network services, or overlay networks (with the NEs 570A-H of the data plane 580 being the underlay network)) for the application(s) 588. Thus, the centralized control plane 576 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 5D shows the distributed approach 572 separate from the centralized approach 574, the effort of network control may be distributed differently or the two combined in certain embodiments of the invention. For example: 1) embodiments may generally use the centralized approach (SDN) 574, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 574, but may also be considered a hybrid approach.

While FIG. 5D illustrates the simple case where each of the NDs 500A-H implements a single NE 570A-H, it should be understood that the network control approaches described with reference to FIG. 5D also work for networks where one or more of the NDs 500A-H implement multiple VNEs (e.g., VNEs 530A-R, VNEs 560A-R, those in the hybrid network device 506). Alternatively or in addition, the network controller 578 may also emulate the implementation of multiple VNEs in a single ND. Specifically, instead of (or in addition to) implementing multiple VNEs in a single ND, the network controller 578 may present the implementation of a VNE/NE in a single ND as multiple VNEs in the virtual networks 592 (all in the same one of the virtual network(s) 592, each in different ones of the virtual network(s) 592, or some combination). For example, the network controller 578 may cause an ND to implement a single VNE (a NE) in the underlay network, and then logically divide up the resources of that NE within the centralized control plane 576 to present different VNEs in the virtual network(s) 592 (where these different VNEs in the overlay networks are sharing the resources of the single VNE/NE implementation on the ND in the underlay network).

On the other hand, FIGS. 5E and 5F respectively illustrate exemplary abstractions of NEs and VNEs that the network controller 578 may present as part of different ones of the virtual networks 592. FIG. 5E illustrates the simple case of where each of the NDs 500A-H implements a single NE 570A-H (see FIG. 5D), but the centralized control plane 576 has abstracted multiple of the NEs in different NDs (the NEs 570A-C and G-H) into (to represent) a single NE 5701 in one of the virtual network(s) 592 of FIG. 5D, according to some embodiments of the invention. FIG. 5E shows that in this virtual network, the NE 5701 is coupled to NE 570D and 570F, which are both still coupled to NE 570E.

FIG. 5F illustrates a case where multiple VNEs (VNE 570A.1 and VNE 570H.1) are implemented on different NDs (ND 500A and ND 500H) and are coupled to each other, and where the centralized control plane 576 has abstracted these multiple VNEs such that they appear as a single VNE 570T within one of the virtual networks 592 of FIG. 5D, according to some embodiments of the invention. Thus, the abstraction of a NE or VNE can span multiple NDs.

While some embodiments of the invention implement the centralized control plane 576 as a single entity (e.g., a single instance of software running on a single electronic device), alternative embodiments may spread the functionality across multiple entities for redundancy and/or scalability purposes (e.g., multiple instances of software running on different electronic devices).

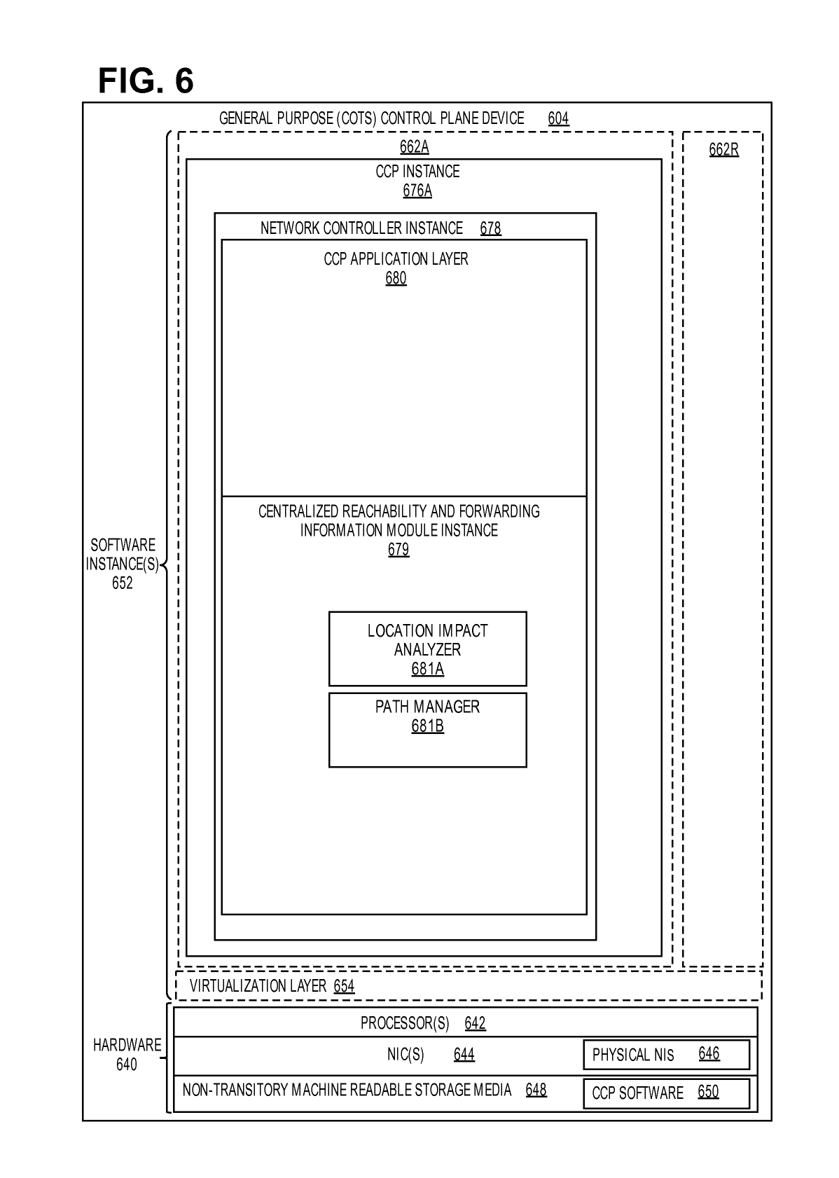

Similar to the network device implementations, the electronic device(s) running the centralized control plane 576, and thus the network controller 578 including the centralized reachability and forwarding information module 579, may be implemented a variety of ways (e.g., a special purpose device, a general-purpose (e.g., COTS) device, or hybrid device). These electronic device(s) would similarly include compute resource(s), a set or one or more physical NICs, and a non-transitory machine-readable storage medium having stored thereon the centralized control plane software. For instance, FIG. 6 illustrates, a general purpose control plane device 604 including hardware 640 comprising a set of one or more processor(s) 642 (which are often COTS processors) and network interface controller(s) 644 (NICs; also known as network interface cards) (which include physical NIs 646), as well as non-transitory machine readable storage media 648 having stored therein centralized control plane (CCP) software 650.

In embodiments that use compute virtualization, the processor(s) 642 typically execute software to instantiate a virtualization layer 654 and software container(s) 662A-R (e.g., with operating system-level virtualization, the virtualization layer 654 represents the kernel of an operating system (or a shim executing on a base operating system) that allows for the creation of multiple software containers 662A-R (representing separate user space instances and also called virtualization engines, virtual private servers, or jails) that may each be used to execute a set of one or more applications; with full virtualization, the virtualization layer 654 represents a hypervisor (sometimes referred to as a virtual machine monitor (VMM)) or a hypervisor executing on top of a host operating system, and the software containers 662A-R each represent a tightly isolated form of software container called a virtual machine that is run by the hypervisor and may include a guest operating system; with para-virtualization, an operating system or application running with a virtual machine may be aware of the presence of virtualization for optimization purposes). Again, in embodiments where compute virtualization is used, during operation an instance of the CCP software 650 (illustrated as CCP instance 676A) is executed within the software container 662A on the virtualization layer 654. In embodiments where compute virtualization is not used, the CCP instance 676A on top of a host operating system is executed on the “bare metal” general purpose control plane device 604. The instantiation of the CCP instance 676A, as well as the virtualization layer 654 and software containers 662A-R if implemented, are collectively referred to as software instance(s) 652.

In some embodiments, the CCP instance 676A includes a network controller instance 678. The network controller instance 678 includes a centralized reachability and forwarding information module instance 679 (which is a middleware layer providing the context of the network controller 578 to the operating system and communicating with the various NEs), and an CCP application layer 680 (sometimes referred to as an application layer) over the middleware layer (providing the intelligence required for various network operations such as protocols, network situational awareness, and user-interfaces). At a more abstract level, this CCP application layer 680 within the centralized control plane 576 works with virtual network view(s) (logical view(s) of the network) and the middleware layer provides the conversion from the virtual networks to the physical view.

Location impact analyzer 681A and path manager 681B can be implemented as modules at the centralized readachailibty and forwarding information module instance 679 level. However, in other embodiments the location impact analyzer 681A and path manager 681 B are implemented as applications in the CCP application layer 680.

The centralized control plane 576 transmits relevant messages to the data plane 580 based on CCP application layer 680 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 580 may receive different messages, and thus different forwarding information. The data plane 580 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 580, the packet (or a subset of the packet header and content) is typically forwarded to the centralized control plane 576. The centralized control plane 576 will then program forwarding table entries into the data plane 580 to accommodate packets belonging to the flow of the unknown packet. Once a specific forwarding table entry has been programmed into the data plane 580 by the centralized control plane 576, the next packet with matching credentials will match that forwarding table entry and take the set of actions associated with that matched entry.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

Throughout the description, embodiments of the present invention have been presented through flow diagrams. It will be appreciated that the order of transactions and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

What is claimed is:

1. A method implemented by a controller in a software defined networking (SDN) network, the network including a set of nodes, the controller in communication with a server providing information about environmental events affecting the SDN network, the method comprising:
receiving information about an environmental event affecting the SDN network;
identifying a subset of the nodes in the SDN network affected by the environmental event based on location information for the subset of nodes;
determining a degree of impact caused by the environmental event for each node in the subset of nodes; and
configuring the SDN network to diminish an impact of the environmental event on the SDN network performance.

2. The method of claim 1, further comprising:
receiving location information for the set of nodes in the SDN network.

3. The method of claim 1, further comprising:
generating impact data for a node in the subset of nodes, the impact data including a degree of impact and timing of impact of the environmental event on the node.

4. The method of claim 3, wherein configuring the SDN network further comprises:
performing a recomputation of paths in the SDN network at a set interval before the timing of the impact.

5. The method of claim 3, wherein configuring the SDN network further comprises:
determining an alternate path to be utilized at a fixed time before the timing of the impact.

6. The method of claim 3, wherein configuring the SDN network further comprises:
sending measurement packets to the node in response to a predetermined interval before the timing of the impact is reached.

7. The method of claim 3, wherein configuring the SDN network further comprises:
receiving measurement packets from the node; and
checking whether the measurement packets indicate that the node has been affected by the environmental event.

8. The method of claim 7, wherein configuring the SDN network further comprises:
updating a topology of the SDN network; and
recomputing paths in the SDN network.

9. The method of claim 7, wherein configuring the SDN network further comprises:
terminating configuring the SDN network in response to a duration of the environmental event elapsing.

10. A network device functioning as a controller in a software defined networking (SDN) network, the SDN network including a set of nodes, the controller in communication with a server providing information about environmental events affecting the SDN network, the network device comprising:
a non-transitory machine readable storage device having stored therein a location impact analyzer and a path manager; and
a processor coupled to the non-transitory machine readable storage device, the processor configured to execute the location impact analyzer and the path manager, the location impact analyzer configured to receive information about an environmental event affecting the SDN network, to identify a subset of the nodes in the SDN network affected by the environmental event based on location information for the subset of nodes, and to determine a degree of impact caused by the environmental event for each node in the subset of nodes, and the path manager configured to configure the SDN network to diminish an impact of the environmental event on the SDN network performance.

11. The network device of claim 10, wherein the location impact analyzer is configured to receive location information for the set of nodes in the SDN network.

12. The network device of claim 10, wherein the location impact analyzer is configured to generate impact data for a node in the subset of nodes, the impact data including a degree of impact and timing of impact of the environmental event on the node.

13. The network device of claim 12, wherein the path manager is configured to perform a recomputation of paths in the SDN network at a set interval before the timing of the impact.

14. The network device of claim 12, wherein the path manager is further configured to determine an alternate path to be utilized at a fixed time before the timing of the impact.

15. The network device of claim 12, wherein the path manager is further configured to send measurement packets to the node in response to a predetermined interval before the timing of the impact is reached.

16. The network device of claim 12, wherein the path manager is further configured to receive measurement packets from the node; and
check whether the measurement packets indicate that the node has been affected by the environmental event.

17. The network device of claim 16, wherein the path manager is further configured to update a topology of the SDN network and recompute paths in the SDN network.

18. The network device of claim 16, wherein the path manager is further configured to terminate configuring the SDN network in response to a duration of the environmental event elapsing.
